(19) United States
(12) Patent Application Publication
(10) Pub. No.: US 2005/0174908 A1
(43) Pub. Date: Aug. 11, 2005

(54) Device for recording data on a medium, method implemented in such a device and recording medium obtained from said device

(76) Inventor: Gheorge S Stan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/511,812

(22) PCT Filed: Apr. 11, 2003
(86) PCT No.: PCT/IB03/01464

(30) Foreign Application Priority Data
Apr. 22, 2002 (EP) 02291026.9

(51) Int. Cl. G11B 7/00; G11B 11/03

(52) U.S. Cl. 369/53.11

(57) ABSTRACT

This device intended to record optical discs 5 comprises a control circuit for controlling the power of the recording laser beam 70 which takes a plurality of parameters into account notably the jitter of the recovered written data which is measured during the reading of recorded data which are produced by a reading block 71. Furthermore, the power may be corrected as a function of the temperature inside the laser housing by measuring the threshold current at which the light is switched on. Other parameters used to correct the laser power take into account the scanning velocity of the disc and the amount of disc tilt. Application: Recording for CD (compact disc), DVD (digital versatile disc), BD (Blu-ray Disc).

The invention relates to a device for recording data on a recording medium which can be written by a recording head unit which produces a recording energy beam, the device comprising:
a control assembly for controlling the intensity of the recording beam,
a set of measures for supplying control data to said control assembly comprising a measuring circuit for measuring the level of the recorded signals,
a database relating to the medium for supplying previous data to said control assembly.

The invention has interesting applications notably in the recording of optical discs by means of laser beam pulses. Due to, on the one hand, various kinds of media involved and, on the other hand, mechanical, electrical, and optical imperfections of the recording devices, it is very difficult to use predefined parameters for the laser pulses. It is thus necessary to make corrections. On this subject European patent document EP 0 762 399 may be consulted. In this document it is proposed to determine the power of the recording pulses on the basis of the level of the recorded signal during a previous recording attempt.

However, it has turned out that, in many cases this determination is not sufficient for obtaining a recording of good quality. Besides the multitude of recordable and rewritable optical media available on the market, each of them with particular characteristics, the recording process is very much influenced by the ambient temperature, ageing of the semiconductor laser, or other factors that can not always be predicted in a well-defined manner.

The present invention proposes a device of the type defined in the opening paragraph which thus permits to obtain a recording of good quality while taking other measures into account than those relating to the level of the recorded signal.

For this purpose, such a recording device is remarkable in that the set of measures comprises additional measuring circuits of the recorded signal.

In a preferred embodiment the device is remarkable in that at least one of the measuring circuit determines parameters through measurements from real time recording conditions.

The inventive idea consists of utilizing and managing a multiplicity of parameters that includes not only those specified by media manufacturers but also parameters established during previous recording stages that took place on the same disc.

The invention also relates to a recording method which is characterized in that it comprises the following steps:
insertion of a medium to be recorded,
identification of the medium,
rejection of the medium if it is unsuitable for recording,
test recording based on a set of default recording parameters,
reading of the test recording,
determining the recording power based on the level of the recorded signals,
correcting of the recording power depending on the timing jitter accompanying the recovered data,
correcting the recording power as a function of a plurality of measured parameters notably the temperature,

It is possible to add steps for correcting the recording power as a function of other measured parameters such as the disc velocity, the amount of disc tilt . . . .

The invention also relates to a recording medium which contains data obtained via said method.

These and other aspects of the invention are apparent from and will be elucidated, by way of non-limitative example, with reference to the embodiment(s) described hereinafter.

In the drawings:

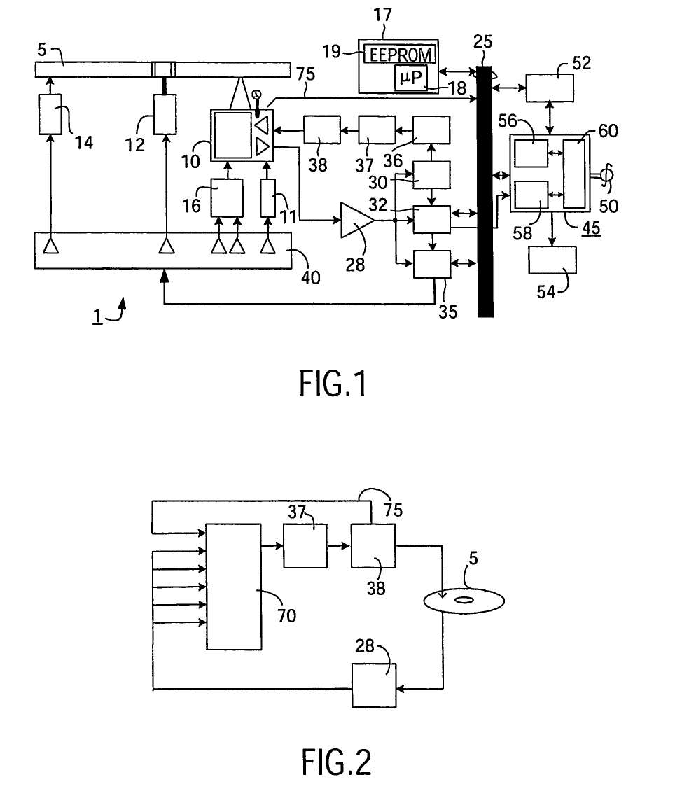

FIG. 1 shows a device in accordance with the invention,

FIG. 2 shows a diagram in explanation of the measures of the invention,

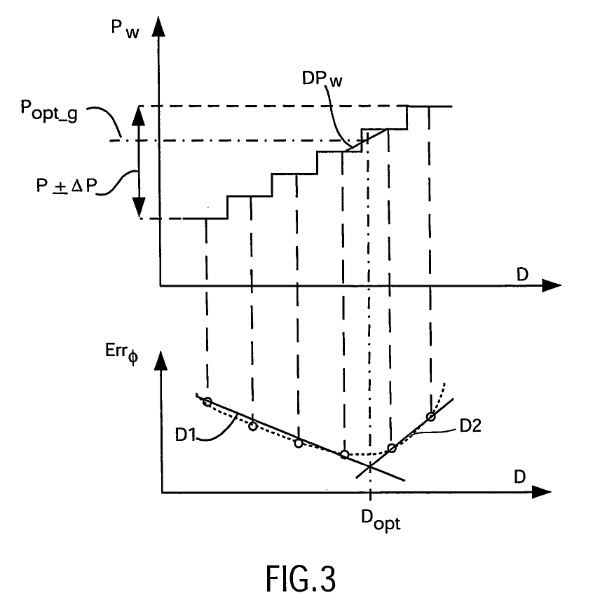

FIG. 3 shows how the power correction is evaluated as a function of jitter,

FIG. 1 shows a device according to the invention referred to as 1. This device 1 is intended to record data on a recording medium 5 along a spiral-shaped winding track, for example. This medium is preferably an optical disc whose optical properties are modified by means of a laser beam pulse coming from an optoelectronic block 10. This block 10 contains at least a laser diode (not shown in the Figure) for permitting the recording of data on the optical disc 5 and also the reading of data which are recorded there. This exposé will also cover etched recording operations. The block 10 comprises a set of mechanisms for focusing the laser beam to accurately follow the etched tracks and also to permit the displacement of this block. This displacement is represented by a motor 11. The disc 5 is rotated by means of a motor 12. Reference 14 also indicates the motor used for the loading and unloading of the medium 5. The device according to the invention is managed by a microprocessor assembly 17. This assembly comprises inter alia a microprocessor 18 and a rewritable EEPROM memory referred to as 19. The data used and produced by this assembly 17 are transmitted over a common data line 25 (BUS line).

The signals coming from block 10 are first of all processed by a signal pre-processor 28. The signals coming from this processor are subsequently processed by a format detector 30 which defines the structure of the optical disc 5. This format detector supplies data to a channel decoder 32 which, inter alia, supplies data to a servocontrol group 35 for controlling the various slaves of the device already mentioned while also using data from the pre-processor 28. Before being applied to the motors, these signals are amplified by an amplifier assembly 40. A unit controls the power of the laser for engraving the disc 5. The unit comprises a channel coder 36 followed by a writing strategy circuit 37 and a laser power control circuit 38.

A processing block 45 connected to the line 25 permits the user to access various functionalities of the device. This is represented by terminal 50. This block utilizes a memory assembly 52. If needed, the retrieved data may also processed by an audio/video processor 54. The processing block 45 comprises a coding/decoding circuit 56, a buffer memory management circuit 58 and an interface circuit 60 which ensures, inter alia, that the levels of the signals intended for this use are taken into account.

FIG. 2 shows in diagrammatic manner the elements which are involved in the invention. The elements common to those of the preceding Figure carry like references. A block 70 is depicted which contains functionalities contained in the various elements shown in FIG. 1 which ensure the implementation of the invention. This block determines the recording laser beam power as a function of the various parameters which are used by the invention.
Scanning speed of the laser spot as it proceeds from the inside of the disc to its periphery.
Jitter. Jitter is measured while taking into account the phase errors that occur while synchronizing the regenerated binary data with the regenerated clock frequency used as reference. FIG. 3 shows how this jitter value determines a correction of the intensity of the laser beam. Several consecutive recordings are performed with increasing (or decreasing) laser powers starting from a previously determined value P and by incremented this value in steps ΔP, not necessarily equal to each other. For each of these power levels the jitter Errφ is measured by reading out the recorded data. The value Pₒₚₜ_{_{—}}_{g} is determined by interpolation, which gives the minimum error. In the Figure the interpolation established by means of straight lines D1 and D2 which best pass through the jitter measuring points and whose intersection produces a value Dₒₚₜ (distance between the power changes which in its turn gives the value of the power between two value increments). This value is established on a straight power line DP_{W}. Other methods for finding the minimum jitter value may also be applied.
Defects on disc. The recording power may need adjustment when the laser beam has to pass through some defects present on the disc surface, like fingerprints, in which case usually more power is needed for writing.
Temperature of the laser. The temperature can be estimated by measuring the current supplied to the laser diode such that the light is just switched on, which corresponds to the so-called bias power. This current is fed to the laser diode by the laser driver 38. A power correction will be commanded as a function of the value of this current. This process will be continued during the actual recording phase by measuring the bias current between laser pulses. Estimation of the laser temperature is, however, not limited to the method described herein and may take place, for example, by using a temperature sensor.

Determining the recording laser power involves either calibration procedures consisting of writing sequences of test patterns in dedicated test areas on disc or using the information recorded during normal operation. The latter can be read out during the idle moments in which the optical unit does not receive data through the interface 50. As for the test areas, the optical media standards provide at leat one such are situated at the inner disc radius and, in some cases, a second test area situated close to the disc edge.

The invention particularly relates to a power control procedure for controlling the emission of the laser beam called OPC (Optimal Power Control). The operation of the device according to the invention described more particularly within the framework of optical discs, satisfying the various standards for recordable and rewritable CD and DVD media or any other optical media with recording characteristics. Example of such media are CD-R, CD-RW, DD-R, DD-RW, DVD-R, DVD-RW, DVD-RAM, DVD+R, DVD+RW, Blu-ray Disc, etc. The application of the invention will be discussed below by means of an example, in particular, by showing how the laser power can be adjusted based on a multitude of parameters in a DVD+R recorder. The following sequence of operations are performed:

1 A start is made with the insertion of the medium (optical disc) 5.

2 The identification of this medium and also of its manufacturer is searched for.

3 Parameters stored in the lead-in area of the disc are recovered and, if there is no data whatsoever in this area, these parameters adopt default values.

4 Recovery of the recording parameters previously stored in the EEPROM memory 19. The memory 19 has been loaded with such parameters during previous recording sessions that use discs of the same type and from the same manufacturer. These parameters constitute thus a database in which the newly inserted optical disc 5 may be found.

5 Reading of the OPC counting location to determine the sequences to be carried out for a new power calibration procedure.

6 Execution of the OPC procedure.

7 Updating of the parameters in the EEPROM memory 19.

However, before proceeding with an OPC sequence on an optical disc which has just been inserted into the device, it is necessary to examine the following possibilities:

A The inserted disc is fully blank, thus the procedure may be started in normal fashion.

B The inserted disc has been recorded partially and sufficient place remains for carrying out at least a power calibration operation. The OPC procedure will be executed and the parameters stored in the memory 19 during a previous recording operation will also be used.

C Examination of the situation according to which a disc has already been written and there is no more place for carrying out an OPC procedure. In the latter case a decision is to be made to know whether a new recording is made by means of at least certain parameters by default or whether the recording process is stopped.

D The inserted disc has been recorded completely and is recognized as being finalized. It is not necessary to start the etching operation.

Having available the various system information (e.g. identification data, recording parameters) and also the data contained in the EEPROM memory 19, one proceeds with the reading of the OPC counting location. In this area the number of ECC blocks already used for previous calibration procedures is found. The location PSN_{opc}_{_{—}}ₛₜₐᵣₜ from where the calibration sequence will start is determined,
PSN_{opc}_{_{—}}ₛₜₐᵣₜ=23480+4×(27480−PSN_{icz}_{_{—}}_{first}),
where PSN_{icz}_{_{—}}_{first} represents the physical address of the first empty sector of the counting area.
Loading of Indicative Recording Parameters

If there are no indicative values related to the recording process on a particular medium, values by default are admitted included in the EEPROM memory 19. These values are chosen for a particular scanning velocity at which the disc has to be written.

| | | | | λ_{ind}_{_{—}}_{def} | |
|---|---|---|---|---|---|
| | P_{ind}_{_{—}}_{def} | | β_{ind}_{_{—}}_{def} | [nm] | K_{λ}_{_{—}}_{def} |
| | [mW] | | 1X and | 1X and | 1X and |
| DVD + R support | 1X | 2.4X | 2.4X | 2.4X | 2.4X |
| Media manufacturer | 10.0 | 15.0 | 0.08 | 655 | 10 |
| no. 1 | | | | | |
| Media manufacturer | | | 0.02 | | 7 |
| no. 2 | | | | | |
| Without indication | | | 0.05 | | 8.5 |

The coefficients K_{λ}_{_{—}}_{def} represent the normalized dependence of the laser power taking the wavelength of the laser into account. The nominal value is given by

$${K}_{λ} = \frac{ⅆ P}{ⅆ λ} \cdot \frac{{λ}_{ind}}{{P}_{ind}} \qquad ( 1 )$$

If one wishes to take the ambient temperature into account, a correction may be made using the following formula:

$${P}_{w} = {K}_{x} \{ {P}_{ind} + {K}_{λ} \frac{{P}_{ind}}{{λ}_{ind}} [ {λ}_{opu} - {λ}_{ind} + {K}_{t} ( {T}_{a} - {T}_{s} ) ] \} \qquad ( 2 )$$

where the meaning of the symbols and their default values are given by the table below.

| | | Default | |
|---|---|---|---|
| Parameters | Symbol | Value | Unity |
| Indicative recording power at 1X | P_{ind} | Read from | mW |
| | | disc | |
| Recording overspeed (X-factor) | Kₓ | 1.2 | — |
| Dependence on the normalized laser | K_{λ} | Read from | — |
| power relative to the wavelength. | | disc | |
| Experimental correction for K_{λ} | Kₑₓₚ | 1.5 | — |
| Initial laser wavelength at Tₛ | λₒₚᵤ | 663 | nm |
| Indicative wavelength at which the | λ_{ind} | Read from | nm |
| power P_{ind} has been measured. | | disc | |
| Drift of the wavelength due to | Kₜ | 0.2 | nm/grd |
| variations of the ambient temperature. | | | |
| Ambient temperature | Tₐ | 40 | ° C. |
| Temperature at which the laser | Tₛ | 25 | ° C. |
| wavelength is specified. | | | |

The recording power expressed as a setpoint to be used by the laser driver can be written in the form:

$${P}_{setpoint} = {P}_{w} \cdot {K}_{grating} \cdot \frac{{K}_{loss}}{{P}_{nom}} \cdot {P}_{setpoint\_nom} \qquad ( 3 )$$

in which expression:

| | | Value by | |
|---|---|---|---|
| Parameter | Symbol | default | Unity |
| Estimated recording power. | P_{w} | Cf Eq. (2) | mW |
| Factor due to partitioning of the light | K_{grating} | 16/14 | — |
| bundle in more than one spots on disc | | | |
| Experimental correction factor (due | Kₗₒₛₛ | see below | — |
| to light scatering or other factors. | | | |
| Nominal power of the laser for | Pₙₒₘ | taken from | mW |
| calibration of the laser driver | | (19) | |
| Nominal power setpoint for | Alpha_nom | taken from | — |
| the laser driver. | | (19) | |

| DVD + R media | Kₗₒₛₛ |
|---|---|
| Media manufacturer no. 1 | 1.000 |
| Media manufacturer no. 2 | 0.950 |
| No identification | 0.975 |

A typical value of the nominal laser power for DVD+R media is Pₙₒₘ=10 mW. The correction coefficient Kₑₓₚ is determined experimentally to compensate for various losses in the light power due to, for example, scattering of the light upon entering the transparent substrate of the disc. It compensates for the differences in the measurements made in the start parameters VEMOS and in the recorders of the type DVD+R.

The laser power calculation may take even more variables into account than given in Equation (2). For example, two more coefficients Kₜᵢₗₜ and K_{aberr} may be used to correct for the amount of disc tilt and the amount of aberrations in the optical system, respectively. The formula (2) will become then

$${P}_{w} = {K}_{aberr} {K}_{tilt} {K}_{x} \{ {P}_{ind} + {K}_{λ} \frac{{P}_{ind}}{{λ}_{ind}} [ {λ}_{opu} - {λ}_{ind} + {K}_{t} ( {T}_{a} - {T}_{s} ) ] \} \qquad ( 4 )$$

In addition, note that some parameters may also be adjusted in real time during recording and not only fixed during a calibration procedure that takes place before recording. This is the case, for example, in data drives that record at high speeds where the temperature inside the laser housing may exhibit large variations during operation and the recording speed may change at various locations on disc. Alternatively, the recorder may check the written data during idle periods and determine correction factors based on a jitter measurement.

1. A device for recording data on a recording medium which can be written by a recording head unit which produces a recording energy beam, the device comprising:
a control assembly for controlling the intensity of the recording beam,
a set of measures for supplying control data to said control assembly comprising a measuring circuit for measuring the quality of the recorded signals,
a database relating to the medium for supplying previous data to said control assembly,
characterized in that the set of measures comprises additional measuring circuits of the recorded signal.

2. A device as claimed in claim 1, characterized in that at least one of the measuring circuit determines parameters through measurements from real-time recording conditions.

3. A device as claimed in claim 1 or 2, characterized in that at least one of the measuring circuits is a jitter measuring circuit.

4. A device as claimed in claim 1 or 2 or 3, characterized in that at least one of the measuring circuits is a temperature measuring circuit that operates in real time during recording.

5. A device as claimed in claim 4, characterized in that the temperature measuring circuit is in the form of a circuit for measuring threshold current needed by the semiconductor laser to which on the light.

6. A device as claimed in claim 1 to 5, characterized in that at least one of the parameters supplied to the control control assembly is related to the scanning velocity at which the recording take place.

7. A device as claimed in claim 1 or 6, characterized in that at least one of the measuring circuits is a tilt measuring circuit that operates in real time during recording.

8. A device as claimed in one of the claims 1 to 7, characterized in that at least part of the database is contained at a location of said medium.

9. A device as claimed in one of the claims 1 to 8, characterized in that at least part of the database is contained in one of its memory circuits.

10. A device as claimed in one of the claims 1 to 9, characterized in that the recording medium is in the form of an optical disc.

11. A recording method implemented in a device as claimed in one of the claims 1 to 10, characterized in that it comprises the following steps:
insertion of a medium to be recorded,
identification of the medium,
rejection of the medium if it is unsuitable for recording,
test recording based on said previous data,
reading of the test recording,
determining the recording power based on the level of the recorded signals,
entering a possible correction of said recording power as a function of jitter data,
entering a possible correction as a function of temperature, scanning speed of the disc, the amount of disc tilt or any other parameter that influences substantially the quality of the recorded data,

12. A method as claimed in claim 11, characterized in that the step relating to the correction as a function of temperature, scanning speed, or any other parameter is carried out in real time during the recording of data.

13. A recording medium obtained by the implementation of the method as claimed in one of the claims 11 or 12.

14. A recording medium as claimed in claim 13, characterized in that it is in the form of an optical disc.
